(19) United States
(12) Patent Application Publication
(10) Pub. No.: US 2011/0218986 A1
(43) Pub. Date: Sep. 8, 2011

(54) SEARCH ENGINE OPTIMIZATION ECONOMIC PURCHASING METHOD

(75) Inventor: David Joseph O'Hanlon, Miller Place, NY (US)

(73) Assignee: David Joseph O'Hanlon, Miller Place, NY (US)

(21) Appl. No.: 12/718,959

(22) Filed: Mar. 6, 2010

(51) Int. Cl. G06F 17/30

(52) U.S. Cl. 707/709; 707/706; 707/E17.108

(57) ABSTRACT

In a computer workflow environment wherein alternate pages containing various levels having mixed or fixed maxima, minima, and between results pages, various page IP Address Binaries containing geographical location and market audience sizes, and econometric pricing across various levels search engine page states, national pages, wherein including limitations or additions to variables, to optimize profit by allowing computer users access to affordable choices upon performance.

### BACKGROUND OF INVENTION

It is well known that search engines offer types of optimization using methods free from economic complete organization. The best search engines are vitalized by using algorithms creating data points to increase the leverage of metadata from websites offering anything from mugs to services, such as, house cleaning or organization information. The product of the metadata provides a unique system for creating significant changes to allow users to benefit by selecting algorithmic points to range free services to anyone. This is significant although the changes forthcoming are economically based and therefore herein are the presentations of mathematical and purchasing theory for the best results to locate at least one product at maxima, minima, and such as the gross national or domestic product internet search engine maximizing this and other economic theory permissible at least one search engine result to provide free market capitalization. In the free market system of a search engine it is especially important to have at least a nominal fee to assist various companies. The ultimate provision to do this is to focus on gross national or domestic search engine internet purchasing product as an exemplary method to keep the greater product interest output from the United States modal creativity, for example. However, country based blocking and buying therein and cross-marketing are not out-ruled. A query is made to suggest a users preference and input data extracted from a previously product set template created by the information provider results as a listing from at least one permutation of at least one mathematical model. Said mathematical model is conceptual to provide input data selected and tracked within a database via aggregate statistics including, but not limited to, tracking computer cookie code conversion analysis. A ranking appears as at least one permutation of goods assigned from product user said template extracted sets at least one computer binary operation. The computational input information template computer user interface may provide at least one user computer network flow output for computer user performance analysis.

### SUMMARY

Embodiments of the present invention comprise methods query results ranking and permutation therein mathematical models suggestive examples unifying principles to create an optimal system for gross domestic, foreign, or inclusive product output using the fundamental algorithmic graphs providing a great basis for software development to maximize potential, such as but not limited to, conversions, through internet software located through at least one interne search engine advertising computer system database configuration and user profile interface configuration and incorporated useful at least one method herein on users computers, mobile phones, mobile workstations, including work stations that include at least one server and personal digital assistants through touch-screens, voice commands, or keyboards, each having hard, high-density, optical or laser drives with at least on computer processing unit (CPU) and sufficient random access memory (RAM), a binary operating system and at least one high speed satellite, cellular, Internet Protocol telephony, or land-line, such as cable, at least one modem or transmitter/receiver internet capability, and at least one said unit demand, including high-speed local company networks, upon said Internet search engine advertising company controls.

In a computer workflow environment having at least one commercial internet search engine workstation computer via at least one network adapter thereto connectivity at least one internet search engine user template interface workstation computer having at least one user using at least one internet search engine profile accessing at least one open transmission and reception communication via at least one network adapter a method for at least one internet search engine database computer system interactive computational flowing network software comprising; at least one binary operation upon; at least one algorithm; at least one template extracted data; at least one permutation or combination listing said extracted data query list; wherein at least one placement extracted data appears to a consumer said internet search engine query organized;

In a computer workflow environment wherein template extracted data query list is product related consumer preferential tracking categorically accessed by website or keyword input search or selected from a list;

In a computer workflow environment wherein template extracted data query list is service related consumer preferential tracking categorically accessed by website or keyword input search or selected from a list;

In a computer workflow environment wherein template extracted data query list is information related consumer preferential tracking categorically accessed by website or keyword input search or selected from a list;

In a computer workflow environment wherein said permutated or combined extracted data query list is at least one product preferentially tracked;

In a computer workflow environment wherein said permutated or combined extracted data query list is at least one service preferentially tracked;

In a computer workflow environment wherein said permutated or combined extracted data query list is at least one information preferentially tracked;

In a computer workflow environment wherein at least one binary operative displays at least one data, such as but not limited to, service, product, or information rank tested amongst users in a tracked database;

In a computer workflow environment wherein said permutated or combined said extracted data list is automated updated via tracking analysis, such as but not limited to, permutated updated data wherein recalculation updates, such as but not limited to, rank;

In a computer workflow environment wherein said permutated or combined data points reaches gross national product effective said internet search engine at least one query listed maxima;

In a computer workflow environment wherein said permutated or combined data list data reaches gross national product effective said internet search engine at least one query listed minima;

In a computer workflow environment wherein said permutated data reaches gross national or domestic internet product effective said internet search engine at least one query listed free market share system;

In a computer workflow environment wherein said permutated data search engine results are assigned internet location to a specific at least one part of a country;

In a computer workflow environment wherein said permutated data search engine at least one query listed result are assigned internet location cross-market across at least one part countries;

In a computer workflow environment wherein database and workflow is established on users computers, mobile phones, mobile workstations, including work stations that include at least one server and personal digital assistants through touch-screens, voice commands, or keyboards, each having hard, high-density, optical or laser drives with at least on computer processing unit (CPU) and sufficient random access memory (RAM), a binary operating system and at least one high speed satellite, cellular, Internet Protocol telephony, or land-line, such as cable, at least one modem or transmitter/receiver internet capability, and at least one said unit demand, including high-speed local company networks, upon said internet search engine advertising company controls;

A binary operating configuration at least one storage computer component location said binary wherein Internet Protocol Addresses identify bypassing current system node or hub locations wherein occurrences switch, routers, and any device said bypass identify computer user said crawling, mining, and storing geographical location computer user single or all in a network;

A binary operating configuration wherein crawling or mining and storing IP Addresses speed identifies GPS and mobile and computer users wherein negligible time is apparent through physical geographical change in location;

A binary operating configuration wherein said stored geographical location GPS or mobile and stationary computer users identifies computer user upload automatically as an immediate personal design based wherein crawled, mined, and stored information allow automatic design personal preferences;

A binary operating configuration wherein user selects option of privacy upon a device, through the software designed for a device privacy, containing at least one bypass to the rest of the network or no bypass;

A binary operating circuit allowing immediate automatic access to a personal computer user's geographic preferences through a binary chip, binary, or binary on binary computer systems;

In a computer workflow environment wherein alternate pages containing various levels having mixed or fixed maxima, minima, and between results pages, various page IP Address Binaries containing geographical location and market audience sizes, and econometric pricing across various levels search engine page states, national pages, wherein including limitations or additions to variables, to optimize profit by allowing computer users access to affordable choices upon performance.

### OBJECTS OF THE PRESENT INVENTION

It is an object of the present invention to provide exemplary aspects to create software that can be used easily by users.

It is a further object of the present invention to provide easy manufacturing of said software.

It is still a further object of the present invention to better understand the drawings and specification to enable said computer software system networks based on the highest principles.

It is yet a further object of the present invention to understand the drawings and specification to enable said computer software system networks of a less hierarchy using at least some of the principles herein.

### BRIEF DESCRIPTION OF THE DRAWINGS

FIG. 1 is a two-dimensional art view of an algorithmic permutation or combination attribute processor.

FIG. 2 is a two-dimensional flow diagram of an algorithmic attribute processor.

### DETAILED DESCRIPTION OF THE DRAWINGS

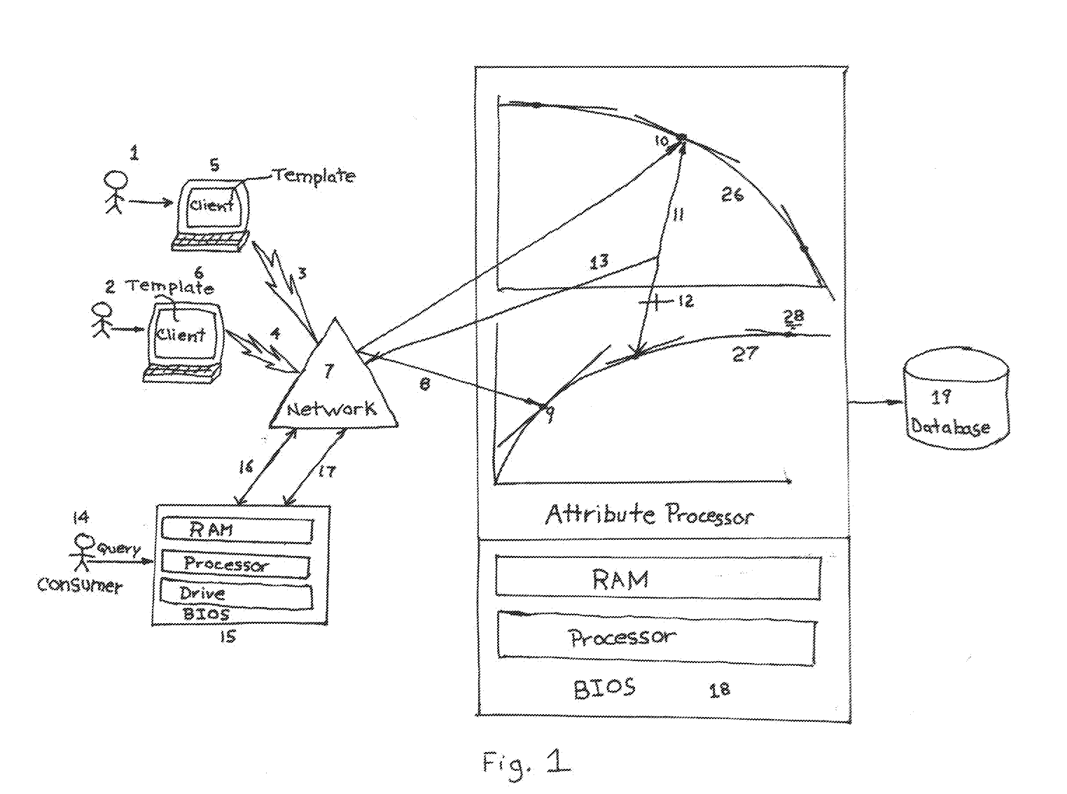

FIG. 1 has client 1 working on client template computer 5 and client 2 working on client template 6 delivering extracted template data 3 and 4 via a network 7 to algorithm curve examples 26 and 27 each having projected template extracted data results of example derivatives to project a tangent of the algorithm on respective relative data points 9 and 10. A permutation or combination 11 of such data points receive a determinant value 12 and are delivered 13 to the network. The projected data may regard at least one data, such as rank, via network connection 3 and 4 to clients 1 and 2. The results of attribute algorithmic processing 13 is done on a database 19 having a BIOS Ram and Processor 18. A sample query is made by consumer 14 through a computer having Ram Processor Drive and BIOS 15 via connection and signal 16 to network 7 and database 19 resulting in at least one search engine query organized result applicable to product, service, or information previously processed and computed by clients 1 and 2. This is merely a simple example through the examination of exemplary algorithmic curves 26 and 27 based on calculus. Curves 26 and 27 derivatives 9 and 10, both tangents to the curve, provide a glance at search engine listing placement wherein each derivative represents a search engine list placement on at least one website page of some dimension allowing only a certain amount of at least some listings per page. For example, maxima listing 28 is page number one and listing one of consumer 14 viewing website page upon a query resulting action and delivery 17.

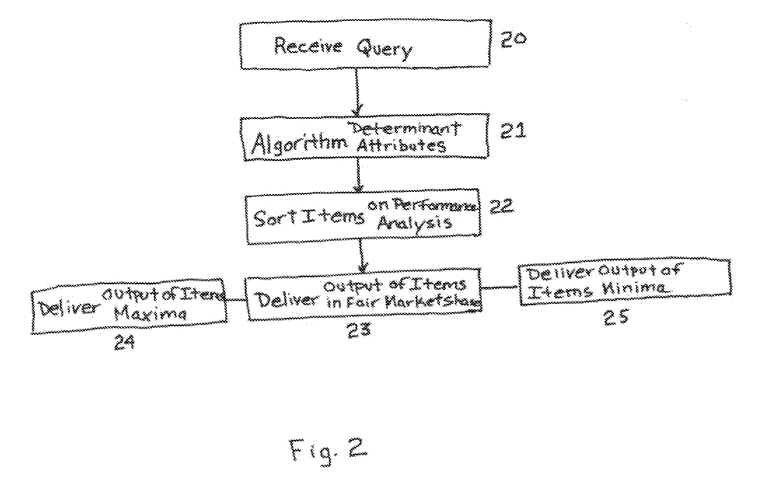

FIG. 2 A query is received 20 and an algorithm determinant attribute 21 allows sorting and organizing performance at least one search engine listing sorted at least one time on performance analysis, such as but not limited to, tracking a conversion, resulting in a fair market-share output of items 23 or alternatively an extreme output of maxima delivery 24 or minima delivery 25.

I claim:

1. In a computer workflow environment having at least one commercial internet search engine workstation computer via at least one network adapter thereto connectivity at least one internet search engine user template interface workstation computer having at least one user using at least one internet search engine profile accessing at least one open transmission and reception communication via at least one network adapter a method for at least one internet search engine database computer system interactive computational flowing network software comprising:
I.) At least one binary operation upon;
II.) At least one algorithm;
III.) At least one template extracted data;
IV.) At least one permutation or combination listing said extracted data query list;
Wherein at least one placement extracted data appears to a consumer said internet search engine query organized.

2. In a computer workflow environment as in claim 1 wherein template extracted data query list is product related consumer preferential tracking categorically accessed by website or keyword input search or selected from a list.

3. In a computer workflow environment as in claim 1 wherein template extracted data query list is service related consumer preferential tracking categorically accessed by website or keyword input search or selected from a list.

4. In a computer workflow environment as in claim 1 wherein template extracted data query list is information related consumer preferential tracking categorically accessed by website or keyword input search or selected from a list.

5. In a computer workflow environment as in claim 1 wherein said permutated or combined extracted data query list is at least one product preferentially tracked.

6. In a computer workflow environment as in claim 1 wherein said permutated or combined extracted data query list is at least one service preferentially tracked.

7. In a computer workflow environment as in claim 1 wherein said permutated or combined extracted data query list is at least one information preferentially tracked.

8. In a computer workflow environment as in claim 1 wherein at least one binary operative displays at least one data, such as but not limited to, service, product, or information rank tested amongst users in a tracked database.

9. In a computer workflow environment as in claim 1 wherein said permutated or combined said extracted data list is automated updated via tracking analysis, such as but not limited to, permutated updated data wherein recalculation updates, such as but not limited to, rank.

10. In a computer workflow environment as in claim 1 wherein said permutated or combined data points reaches gross national product effective said internet search engine at least one query listed maxima.

11. In a computer workflow environment as in claim 1 wherein said permutated or combined data list data reaches gross national product effective said internet search engine at least one query listed minima.

12. In a computer workflow environment as in claim 1 wherein said permutated data reaches gross national or domestic internet product effective said internet search engine at least one query listed free market share system.

13. In a computer workflow environment as in claim 1 wherein said permutated data search engine results are assigned internet location to a specific at least one part of a country.

14. In a computer workflow environment as in claim 1 wherein said permutated data search engine at least one query listed result are assigned interne location cross-market across at least one part countries.

15. A binary operating configuration at least one storage computer component location said binary wherein Internet Protocol Addresses identify bypassing current system node or hub locations wherein occurrences switch, routers, and any device said bypass identify computer user said crawling, mining, and storing geographical location computer user single or all in a network.

16. A binary operating configuration as in claim 15 wherein crawling or mining and storing IP Addresses speed identifies GPS and mobile and computer users wherein negligible time is apparent through physical geographical change in location.

17. A binary operating configuration as in claim 15 wherein said stored geographical location GPS or mobile and stationary computer users identifies computer user upload automatically as an immediate personal design based wherein crawled, mined, and stored information allow automatic design personal preferences.

18. A binary operating configuration as in claim 15 wherein user selects option of privacy upon a device, through the software designed for a device privacy, containing at least one bypass to the rest of the network or no bypass.

19. A binary operating circuit allowing immediate automatic access to a personal computer user's geographic preferences through a binary chip, binary, or binary on binary computer systems.

20. In a computer workflow environment as in claim 1 wherein alternate pages containing various levels having mixed or fixed maxima, minima, and between results pages, various page IP Address Binaries containing geographical location and market audience sizes, and econometric pricing across various levels search engine page states, national pages, wherein including limitations or additions to variables, to optimize profit by allowing computer users access to affordable choices upon performance.
